(19) United States
(12) Patent Application Publication
(10) Pub. No.: US 2001/0046535 A1
(43) Pub. Date: Nov. 29, 2001

(54) Printing on foods

(76) Inventor: Stephen Bowling, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 09/815,851

(22) Filed: Mar. 23, 2001

Related U.S. Application Data
(60) Provisional application No. 60/192,062, filed on Mar. 24, 2000.

(51) Int. Cl. A23L 1/00

(52) U.S. Cl. 426/87; 426/88

(57) ABSTRACT

A method of manufacturing a product, and a product, in which a logo and/or trademark of a sports team, league or association is applied to the food product. The method of applying the logo and/or trademark includes ink jet printing, or printing with a roller or plate with an edible coating, or branding with a hot grill element.

### FIELD OF THE INVENTION

The invention relates to a method of merchandising sports logos and sports-related trademarks. Particularly, the invention relates to a method of merchandizing sports logos and sports trademarks decorating surfaces of food products and food related items.

### BACKGROUND OF THE INVENTION

Merchandising, are the practice of applying licensed trademarks to a variety of products, is a common practice in the entertainment and sports industries. The owners of sports and entertainment properties are always interested in new opportunities and methods for maintaining and further developing the public awareness and interest in the properties and trademarks. As an example, sports and entertainment logos are a common decorative element in clothing or luggage.

Having recognized the value of business cooperation, the licensors and licenses of sports and entertainment properties have successfully provided the market with a variety of clothing and other products decorated with sports and other logos.

Logos of sports associations and individual teams are a particular favorite, and the licensing of such logos to clothing manufacturers and broadcasting companies generates a significant income for professional and collegial sports associations (NBA, NCAA) as well as for individual professional and college athletic teams.

The food industry has often used individual endorsements by sports and also uses individual logos of sports teams that are typically placed on packaging and boxes. As an example, Wheaties® cereal has used logos of sports team under license in connection with pictures of athletes.

However, food products, such as frankfurters, breads, baked goods, and the like have not been decorated with such logos on their surfaces. The food industry has available variety of methods of marking the surface of food products. Thus, for example, it has been proposed to improve the aesthetic appeal of processed meats by providing the food products with surface ornamentation by branding and/or printing (for example, by printing grill marks on a hot dog, or hamburger patty).

The method of branding typically comprises depressing the surface of porous foods with a hot metal grilling surface such as a sandwich iron which contains a desirable ornament. The method of printing comprises printing with edible ink on the food surface.

Utilization of either of these methods will depend on the particular look desired, and the particular foodstuff involved. It is possible to print on the outside of foods, but in some cases this will result in a poor or blurry image. In such case it is preferable to print on food such hot dogs in accordance with the disclosure of U.S. Pat. No. 5,084,283, the disclosure of which is hereby incorporated by reference. As disclosed herein, a particularly effective method of applying an ornament to a hot dog is to use a carmel food coloring, and to apply the ornament by printing it in reverse image on the hot dog casing. The casing is then turned inside during the filling process, so that the ornament is visible in correct orientation, and after manufacture, it is located on the inside of the casing, where there is less risk of degradation or loss of the imprinted image during cooking. As might be imagined, heat activated edible inks (such as a carmel-based color) will be particularly effective in a process wherein the food will be cooked prior to presentation to the customer.

It is, therefore, desirable, to provide a method of applying trademarks and logos of sports associations and sports teams as decoration for the surfaces of foodstuffs and food related products.

### SUMMARY OF THE INVENTION

It is an object of the invention to provide a food product having its surface decorated with a logo and/or trademark which is associated with a sports enterprise selected from the group consisting of sports associations and sports teams.

It is an object of the invention to provide food products imprinted or branded with the logos or trademark that can increase concession sales at stadiums hosting sports events including, but not limited to, baseball, basketball, football or hockey games. Also, such food products can be sold to retail customers through supermarkets and other normal food distribution channels, including the restaurant trade.

In accordance with one aspect of the invention, edible inks can be directly sprayed onto the surface of food products in order to decorate these products with either a logo or trademark of a sports association or sports team.

Also, while baking or cooking a food product, it is possible to decorate it with a sports related logo or trademark by employing a grilling method. In this case, the depressed regions of the foodstuff's surface will brown to a degree which is different from the surrounding regions of the product's surface. As a result, the depressed surfaces provide a well-contrasted three-dimensional decoration after the product has been baked.

In accordance with still another aspect of the inventive method, spraying or rolling a food substance onto the food accomplishes printing on foods. For example, for bread type foods, an egg mixture can be sprayed or applied by a roller or printing plate to the dough, and when baked the egg mixture will brown at a different rate from the dough, thereby creating a visible image on the baked product.

It is therefore an object of the invention to provide methods of applying logos and/or trademarks of a sports enterprise (including sports teams, sports leagues and sports associations) for the purpose of decorating foodstuffs, and the products of such methods.

It is another object of the invention to provide a method of applying logos and trademarks of sports enterprises to the surface of foodstuffs by printing these decorations with edible inks on or by branding the surfaces of the foodstuffs, and the product of such method.

Yet another object of the invention is to provide a method of applying logos and trademarks of sports enterprises to the surfaces of foodstuffs by spraying or rolling a food substance onto the food, and the product of such method.

### BRIEF DESCRIPTION OF THE DRAWINGS

FIG. 1 is a view of a hot dog carrying a logo associated with a sports enterprise and imprinted on the hot dog's surface in accordance with the inventive method.

FIG. 2 is a view of a food product having a logo which is provided on the food product's surface in accordance with the inventive method.

FIG. 3 is an illustration of a method of imprinting of a logo and/or trademarks associated with a sports enterprise by edible inks, or by a food substance, on a food product in accordance with the inventive merchandising method.

FIG. 4 is a schematic view of a hollow roller having an outer surface which is provided with an array of holes delivering a food substance from the interior of the roller onto a food product and arranged to replicate a logo and/or trademark which are associated with a sports enterprise.

FIG. 5 is a schematic view of a grill plate carrying a plurality of branding irons, each of which has a logo and/or trademark associated with a sports enterprise and applied to a food product in accordance with the inventive merchandising method.

FIG. 6 is a schematic view of a roller an outer surface of which has a plate with logos or/and trademarks associated with a sports enterprise and elevated with respect to the outer surface of the roller for branding a food product in accordance with the inventive merchandising method.

FIG. 7 is a schematic view of a roller provided with an arrangement replicating a logo or trademark of a sports enterprise for branding a food prod product in accordance with the inventive merchandising method.

### DETAILED DESCRIPTION OF THE DRAWINGS

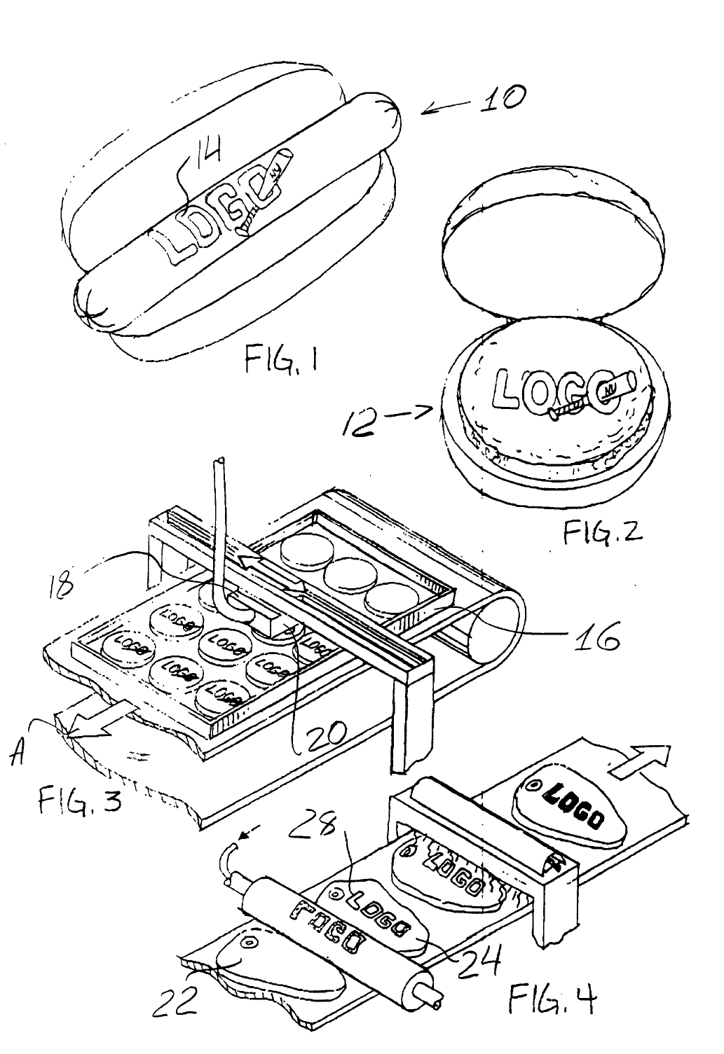

Referring to FIGS. 1 and 2 the bodies of food products such as a hot dog 10 and a hamburger 12, respectively, have a sports team logo 14 applied onto their outer surfaces. It is foreseen that food products can be decorated with a great variety of logos and trademarks associated with a variety of sports teams and sports associations.

The logo illustrated in FIG. 1 is applied by employing a printing method, wherein edible inks are printed in reverse image on the hot dog casing. The casing is then turned inside during the filling process, so that the ornament is visible in correct orientation.

It is envisioned that the printing method would also be utilized for imprinting logos and trademarks of sports teams and associations on surfaces of baked products, such as cookies. Referring to FIG. 3, an apparatus for implementing this method has a carrier 16 loaded with rows of baked products which travel in a direction of an arrow A under a carriage 18 that is displaceable along each row transversely to the travel direction. The carriage can have at least one cartridge 20 filled with edible inks and be programmed to move relative to each of the baked products in such a manner that the inks are sprayed onto the product to form an image of a desired logo and/or trademark. As known in the art, a variety of regular printers, such as a ink jet printer, can be slightly modified to supply edible inks on foods including baked products, ice cream and chocolate.

The imprinting of logos and trademarks of sports teams and associations can also be applied to bread products. Wraps, such as tortilla wraps and other types of sandwich roll-ups, and flat breads such as pita breads are particularly well suited for use as surfaces on which to imprint a logo or trademark.

In accordance with one aspect of the invention, printing on breads is accomplished by applying a food substance different from dough onto a food product before a baking process begins. For example, the apparatus shown in FIG. 3 can be used to spray an egg mixture onto the dough in accordance with a desired decoration. When baked, the egg mixture will brown to a different degree than the dough, thereby creating a visible image. The egg mixture can optionally include a dye or other coloring agent to add additional color to the product.

Alternatively, the egg mixture or any other suitable edible mixture, which can have a color different from the dough at the end of the baking process, can be applied onto the dough by a roller or printing plate.

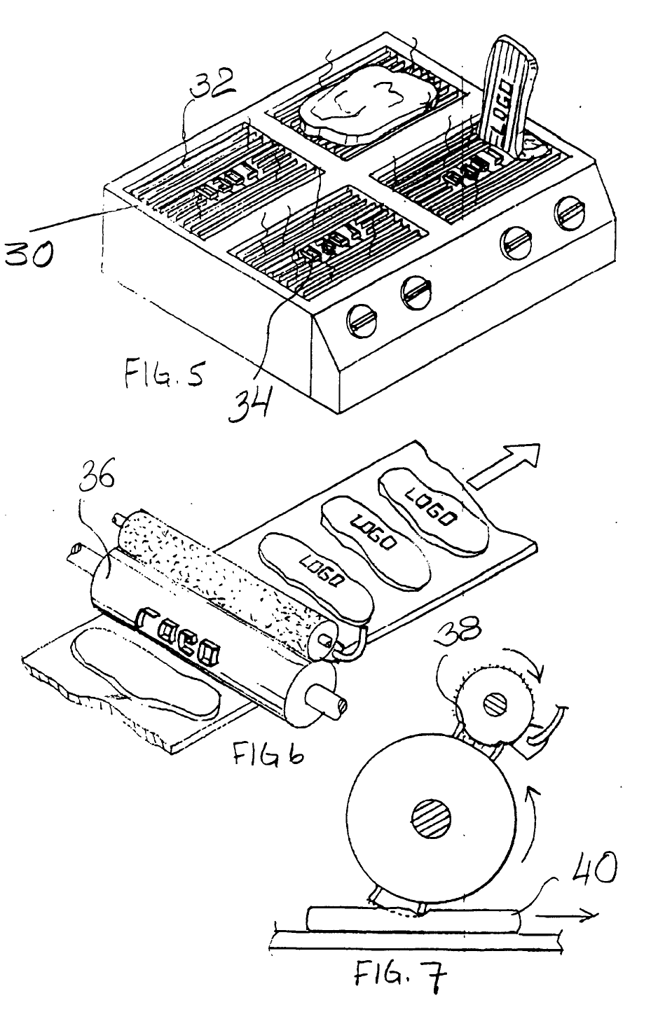

Application of a heat activated “ink” such as an egg mixture is illustrated in FIG. 4. As shown in FIG. 4, a ham steak 22 has an upper surface 24 provided with a decorative pattern 28 replicating the desired logo. The logo is contrasted from a region of the ham steak surrounding this pattern because the heta activated ink, applied onto the ham steak in accordance with the decorative pattern, is characterized by a distinctive color when the product is heated.

The logo illustrated in FIG. 2 is formed on food products by employing a branding method, wherein a grilling surface containing a desirable logo or trademark arrangement is pressed upon foods. It is possible to use a hot sandwich iron 30 shown in FIG. 5 and having at least one plate 32 with an elevated formation 34 corresponding to a desired logo and/or trademark. The iron can be the stationary bottom plate, as shown in FIG. 5, where the plate 32 depresses the surface of products. As a result, after the product is cooked, the depressed areas have a distinct image of the desired logo or trademarks of a sports enterprise. The grilling method is particularly useful for grilled sandwiches, hot dogs, hamburgers and other grilled foods. Alternatively, the plates 34 can be swingable to press against the top of pieces of meet. As a result, the cooked products, which are juxtaposed with the plates 34, have distinct ornaments replicating sports logos and trademarks.

As shown in FIGS. 6 and 7, in addition to the above-described irons, it is possible to print onto food products by employing a roller 36 which has formations elevated from the roller's outer surface and having a contour which is associated with sports logos or trademarks. As the roller rotates, the formations come in contact with a substance 38 differing from a substance 40 of a product, applying the logo to the product.

In an alternative embodiment, the formations are omitted and the printing is by the typical methods of offset printing.

The decoration formed by these steps has a contrasting color representing a distinct visual image of the logo or trademark which is associated with a sports enterprise. In one embodiment of the invention, the food product can itself be shaped with the outline of the logo to be applied (for example, cookies can be cut in a desired shape before baking) and the logo them applied, so that the food product frames and emphasizes the imprinted logo.

Although the invention has been described with reference to a particular arrangements of parts, features and the like, these are not intended to exhaust all possible arrangements or features, and indeed many other modifications and variations will be ascertainable to those of skill in the art.

What is claimed is:

1. A food product comprising:
an edible food body; and
at least one decoration provided on said body, said decoration consisting of a sports enterprise logo, trademark or combination thereof.

2. The food product defined in claim 1 wherein said decoration is applied to said body and said decoration has a decoration color or colors which is different from a body color of said body.

3. The food product defined in claim 1 wherein said decoration is applied to said body by a heated grill element.

4. The food product defined in claim 2 wherein said decoration is applied to said body of application of an edible substance different from said edible food body.

5. The food product defined in claim 4 wherein said decoration comprises an egg mixture.

6. The food product defined in claim 1 wherein said decoration is imprinted on said edible food body.

7. The food product defined in claim 1 wherein said edible food body has a shape corresponding to said decoration.

8. The food product defined in claim 1 wherein said edible food body is selected from the group consisting of meat products, baked dough products, chocolate and ice cream.

9. A method of manufacturing a food product comprising the step of applying a decoration to an edible food product, said decoration being a logo or trademark, or both, associated with a sports enterprise.

10. The method of manufacturing defined in claim 9 wherein said step of applying the decoration includes a step of printing edible inks onto an outer surface of a food product.

11. The method of manufacturing defined in claim 10 wherein said edible inks are printed by an ink jet printer.

12. The method of manufacturing defined in claim 9 wherein said step of applying the decoration includes a step of applying a decorative food substance in accordance with a pattern replicating the decoration to said food product.

13. The method of manufacturing defined in claim 12 wherein the applied decorative food substance is an egg mixture and the food product is a dough product.

14. The method of manufacture defined in claim 13 further comprising baking the food product so that the egg mixture browns to a different degree than the dough thereby providing a visible image of the decoration.

15. The method of manufacturing defined in claim 13 wherein the egg mixture is sprayed onto the food substance of the product.

16. The method of manufacturing defined in claim 13 wherein the egg mixture is rolled onto the food substance of the product.

17. The method of manufacturing defined in claim 9 wherein applying the decoration includes a step of branding the food product within a heated element.

18. The method of manufacturing defined in claim 17 wherein said set of branding of the food product as performed with a heated flat grilling plate or a heated roller.

19. The product of the method of claim 11.

20. The product of the method of claim 14.

21. The product of the method of claim 18.
